(19) United States
(12) Patent Application Publication
(10) Pub. No.: US 2023/0385820 A1
(43) Pub. Date: Nov. 30, 2023

(54) Methods and Systems for Predicting Cash Flow

(71) Applicant: Xero Limited, Te Aro (NZ)

(72) Inventors: Danny Doan, Te Aro (NZ); Allen Qin, Te Aro (NZ); Rebecca Dridan, Te Aro (NZ); Soon-Ee Cheah, Te Aro (NZ)

(21) Appl. No.: 18/200,873

(22) Filed: May 23, 2023

Related U.S. Application Data
(63) Continuation of application No. PCT/NZ2022/050161, filed on Nov. 30, 2022.

(30) Foreign Application Priority Data
May 27, 2022 (AU) 2022901440

(51) Int. Cl. G06Q 20/38

(52) U.S. Cl. CPC G06Q 20/389

(57) ABSTRACT

A computer-implemented method comprises determining a dataset of transactions occurring during a first time period; determining a subset of related transactions from the dataset of transactions, where each transaction in the subset of related transactions shares at least one common attribute; selecting a first transaction interval pattern; selecting a first clustering criteria; based on the first transaction interval pattern and the first clustering criteria, identifying a cluster of transactions from the subset of related transactions; performing a viability check on the cluster; and in response to the cluster passing the viability check, generating a model of periodic transactions, the model including an interval related to the first transaction interval pattern; and a common attribute based on the at least one common attribute.

### CROSS-REFERENCE TO RELATED APPLICATION(S)

This application is continuation of International Patent Application Serial No. PCT/NZ2022/050161, filed on Nov. 30, 2022, which claims priority to and the benefit of Australian Patent Application Serial No. 2022901440, filed May 27, 2022, the entire disclosures of which are hereby incorporated by reference.

### TECHNICAL FIELD

Described embodiments relate to methods and systems for predicting cash flow. In particular, described embodiments relate to systems and methods for predicting cash flow by identifying recurring transactions.

### BACKGROUND

Many businesses that fail do so because of cash flow problems. As a result, effectively predicting future cash flow is important to businesses and trading entities, enabling them to ensure adequate access to funds necessary for operational expenses while making sure that the entity's assets are invested in the most financially productive manner.

However, cash flow over a given time period can be dependent on a wide range of factors including outstanding receivables, obsolete inventory, cost of short term debt, payment obligations, liquidity and trading obligations of trading partner entities, and short term investment yields. Taking into account the large range of dynamic factors is a computationally complex, time and labor intensive operation, and can be an arduous and error prone process.

It is desired to address or ameliorate some of the disadvantages associated with prior methods and systems for predicting cash flow, or at least to provide a useful alternative thereto.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY

Some embodiments relate to a computer-implemented method comprising:
determining a dataset of transactions occurring during a first time period;
determining a subset of related transactions from the dataset of transactions, where each transaction in the subset of related transactions shares at least one common attribute;
selecting a first transaction interval pattern;
selecting a first clustering criteria;
based on the first transaction interval pattern and the first clustering criteria, identifying a cluster of transactions from the subset of related transactions;
performing a viability check on the cluster; and
in response to the cluster passing the viability check, generating a model of periodic transactions, the model including an interval related to the first transaction interval pattern; and a common attribute based on the at least one common attribute.

Some embodiments further comprise marking the transactions of the cluster as used.

Some embodiments further comprise:
selecting a second clustering criteria, the second clustering criteria being more lenient than the first clustering criteria;
based on the first transaction interval pattern and the second clustering criteria, identifying a second cluster of transactions from the subset of related transactions that are not marked as used;
performing a viability check on the second cluster; and
in response to the second cluster passing the viability check, generating a model of periodic transactions, the model including an interval related to the first transaction interval pattern; and a common attribute based on the at least one common attribute.

Some embodiments further comprise:
selecting a second transaction interval pattern, the second transaction interval pattern being longer in duration than the first transaction interval pattern;
based on the second transaction interval pattern and the first clustering criteria, identifying a further cluster of transactions from the subset of related transactions that are not marked as used;
performing a viability check on the further cluster; and
in response to the further cluster passing the viability check, generating a model of periodic transactions, the model including an interval related to the second transaction interval pattern; and a common attribute based on the at least one common attribute.

Some embodiments further comprise, prior to performing the clustering step, filtering the subset of related transactions based on at least one filtering criteria.

According to some embodiments, the filtering criteria is a minimum transaction amount.

Some embodiments further comprise using the model of periodic transactions to predict at least one future recurring transaction having an interval related to the second transaction interval pattern and a common attribute based on the at least one common attribute.

According to some embodiments, performing a viability check on the cluster comprises checking one or more of: the recency of the latest transaction in the cluster; the extent to which the individual transaction intervals of the cluster match a determined pattern; and the number of unique transactions in the cluster.

In some embodiments, checking the recency of the latest transaction in the cluster comprises determining the latest transaction in the cluster, determining the difference between the date of the latest transaction and the current date, and determining if the difference is less than a predetermined threshold, wherein where the difference is more than the predetermined threshold the cluster is determined to be unviable.

In some embodiments, checking the extent to which the individual transaction intervals of the cluster match a determined pattern comprises determining individual transaction intervals by calculating the difference between each transaction and a next occurring transaction; determining a median transaction interval, and comparing the median transaction interval with the interval related to the selected transaction interval pattern; wherein where the median transaction interval does not match the selected transaction interval pattern, the cluster is determined to be unviable.

According to some embodiments, the median transaction interval is a binned median transaction interval, and wherein the binned median transaction interval is calculated by determining individual transaction intervals by calculating the difference between each transaction and a next occurring transaction; rounding each individual transaction interval to the nearest multiple of the selected transaction interval pattern; counting the number of instances of each rounded transaction interval; and determining the binned median transaction interval to be the rounded transaction interval with the highest count.

In some embodiments, checking the number of unique transactions in the cluster comprises determining whether the number of transactions in the cluster is more than a predetermined threshold, wherein where the difference is less than the predetermined threshold the cluster is determined to be unviable.

According to some embodiments, performing a viability check on the cluster comprises performing an interval check, and wherein performing the interval check comprises: determining individual transaction intervals by calculating the difference between each transaction and a next occurring transaction; and determining whether less than half of the individual transaction intervals are zero; wherein if more than half of the rounded individual transaction intervals are zero the cluster is determined to be unviable.

Some embodiments further comprise rounding each individual transaction interval to the nearest multiple of the selected transaction interval pattern before determining whether less than half of the individual transaction intervals are zero.

According to some embodiments, the common attribute is at least one of a common transacting entity; a common bank account name, number or type; a common transaction amount; a common contact name or contact identifier such as business registration number, and/or a common contact address.

In some embodiments, the interval pattern is selected from the group: weekly, fortnightly, monthly, quarterly and yearly.

According to some embodiments, the clustering criteria comprises at least one of a deviation from the selected interval pattern, a difference in transaction amount, and a minimum number of transactions to be clustered.

According to some embodiments, identifying a cluster of transactions from the subset of related transactions based on the first transaction interval pattern comprises calculating an interval difference between at least one pair of transactions in the subset of related transactions.

In some embodiments, calculating an interval difference comprises determining a difference in the day of the month on which the pair of transactions took place.

In some embodiments, calculating an interval difference comprises determining a difference in the day of the week on which the pair of transactions took place.

In some embodiments, determining a difference comprises mapping the days to a circle and determining the shortest number of steps between the days corresponding to the pair of transactions.

In some embodiments, calculating an interval difference comprises mapping the date of the transaction to a trigonometric function, and determining a difference in the trigonometric value corresponding to the dates on which the pair of transactions took place.

Some embodiments relate to a computer-readable medium storing executable instructions which, when executed by a processor, perform the method of some other embodiments.

Some embodiments relate to a computing device comprising the computer-readable medium of some other embodiments and a processor configured to access and execute the instructions stored on the computer-readable medium.

### BRIEF DESCRIPTION OF THE DRAWINGS

FIG. 1 is a schematic of a process for using a capital management platform to predict cash flow of an entity, according to some embodiments.

FIG. 2 is an example screenshot of a visual display provided by the cash flow forecast engine shown in FIG. 1, according to some embodiments.

FIG. 3 is a process flow diagram of a method for forecasting cash flow for an entity, according to some embodiments.

FIG. 4 is a process flow diagram of a method for generating models for predicting recurring transactions associated with entities, according to some embodiments.

FIG. 5 is a process flow diagram of a method for determining a subset of related transactions from a dataset of transactions, according to some embodiments.

FIG. 6 is a block diagram depicting an example application framework, according to some embodiments.

FIG. 7 is a block diagram depicting an example hosting infrastructure, according to some embodiments.

FIG. 8 is a block diagram depicting an example data center system for implementing described embodiments.

FIG. 9 is a block diagram illustrating an example of a machine arranged to implement one or more described embodiments.

### DETAILED DESCRIPTION

Described embodiments relate to methods and systems for predicting cash flow. In particular, described embodiments relate to systems and methods for predicting cash flow by identifying recurring transactions.

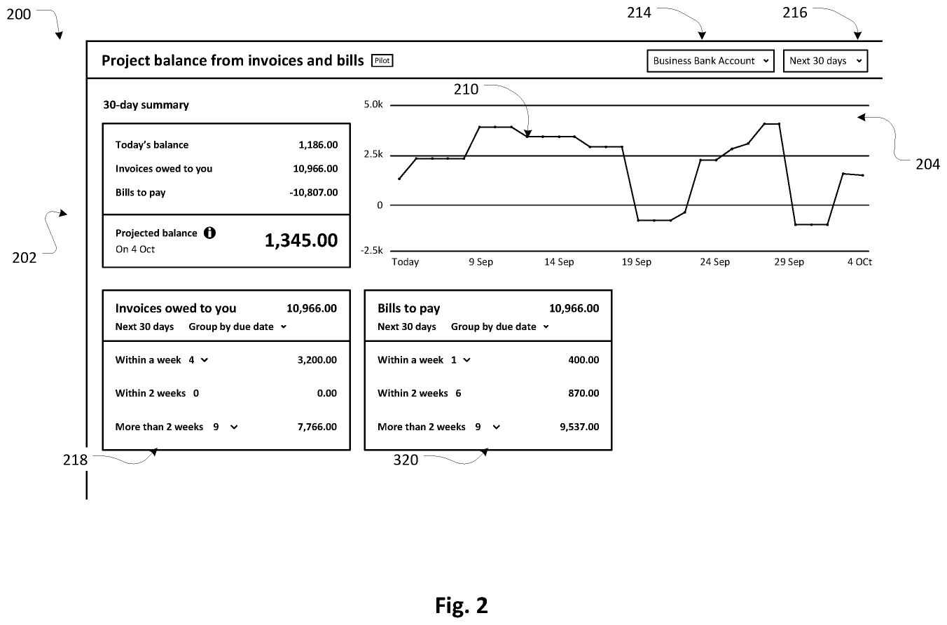

In some embodiments, a capital management platform including a cash flow forecasting platform or tool is provided. The capital management platform is configured to determine predicted capital shortfalls and/or capital surpluses of an entity for a given period of time. The capital management platform may be configured to generate, on a user interface, a visual display of a predicted cash flow of the entity for the period of time based on the predicted capital shortfalls and/or capital surpluses. For example, the visual display may comprise a graphical representation of the predicted cash flow for each day of the time period. An example of such a graphical representation is presented in FIG. 2, and is discussed in more detail below.

The capital management platform may be configured to determine the predicted capital shortfalls and/or capital surpluses at a particular point or day in a given time period based on an assessment of financial data associated with the entity. Financial data associated with an entity may comprise banking data, such as banking data received via a feed from a financial institution, accounting data, payments data, assets related data, transaction data, transaction reconciliation data, bank transaction data, expense data, tax related transaction data, inventory data, invoicing data, payroll data, purchase order data, quote related data or any other accounting entry data for an entity. The financial data may comprise one or more financial records, which may be transaction records in some embodiments. Each financial record may comprise a transaction amount, a transaction date, one or more due dates and one or more entity identifiers identifying the entities associated with the transaction. For example, financial data relating to an invoice may comprise a transaction amount corresponding to the amount owed, a transaction date corresponding to the date on which the invoice was issued, one or more payment due dates and entity identifiers indicating the invoice issuing entity and the entity under the obligation to pay the invoice. Financial data may also comprise financial records indicating terms of payment and other conditions associated with the financial transaction associated with the financial data.

In some embodiments, the capital management platform may be configured to predict capital shortfalls and/or capital surpluses for a primary entity over a time period based on data relating to historical or current transaction data, or patterns of transaction data. In some embodiments, the capital management platform may be configured to identify recurring transactions in a database of transactions (for example, past transactions) and generate a model for predict future recurring transactions. The model may then be used by the platform to predict recurring transactions for a given time period, which can then be used by the platform to determine or predict a baseline cash flow forecast.

Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

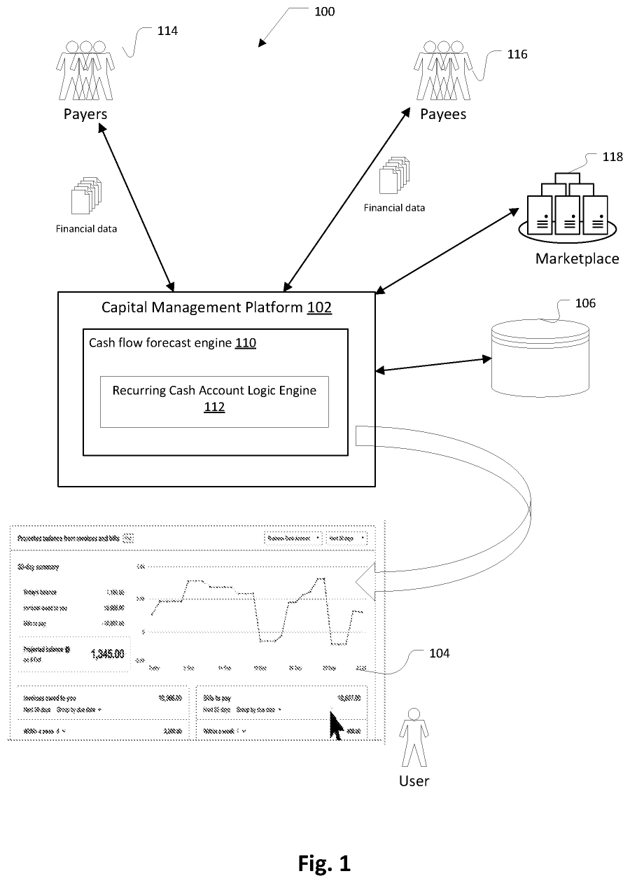

FIG. 1 illustrates a process 100 for using a capital management tool to improve capital management of an entity by forecasting future cash flow of the entity over a predetermined time period. In some embodiments, a capital management platform 102 may be provided to one or more client devices by one or more servers executing program code stored in memory. According to some embodiments, the capital management platform 102 may have the features and functions as described in PCT/AU2020/050924 and/or PCT/AU2020/051184, the entire contents of both of which are incorporated herein by reference. The capital management platform 102 may provide the cash flow forecast engine 110 for use by users of the one or more client devices. In some embodiments, the capital management platform 102 is arranged to communicate with a database 106 comprising financial information associated with a network of entities associated with the capital management platform 102, and may, for example, include accounting data for transactions between two or more entities. Accordingly, analysis of the data allows for inferences about the business interactions or transactions of those entities. For example, computational analysis of historical patterns of transactions between entities and trading behaviors of entities including responsiveness to financial obligations may be used to predict behaviors of the entities.

In some embodiments, database 106 may be part of an accounting system, such as a cloud based accounting system configured to enable entities to manage their accounting or transactional data. The accounting or transactional data may include data relating to bank account transactions or transfers, invoice data, billings data, expense claim data, historical cash flow data, quotes related data, sales data, purchase order data, receivables data, transaction reconciliation data, balance sheet data, profit and loss data, or payroll data, for example. Data in database 106 may enable identification of interrelationships between the primary entity and other entities based on the transactional data. The interrelationships may include relationships that define payment or debt obligations, for example. Based on the interrelationships between the primary entity and other entities, data in database 106 may be used to identify one or more networks of related entities that directly or indirectly transact with each other. Within a network of entities, the financial or cash flow position of one entity may have an impact on the financial or cash flow position of rest of the entities in the network.

The cash flow forecast engine 110 may comprise program code executable by one or more processors of the capital management platform 102. The cash flow forecast engine 110, when executed by the one or more processors of the capital management platform 102, may be configured to predict capital shortfalls and/or capital surpluses of an entity for a given period of time based on information derived from the database 106. For example, the cash flow forecast engine 110 may predict baseline capital shortfalls or baseline capital surpluses based on payment terms of transaction data, such as invoices.

The cash flow forecast engine 110 may comprise a recurring cash account logic engine 112 configured to analyze data relating to cash transactions, which may include petty cash transactions, to predict future cash transactions for the entity. Data relating to cash transactions includes data of payables or receivables in cash that an entity may engage in. The recurring cash account logic engine 112 may employ a predictive model such as a regression model or a trained neural network, for example, and may use historical data relating to cash transactions in order to predict future cash transactions that may be recurring during a given period.

The cash flow forecast engine 110 may be configured to determine a cash flow forecast based on outputs from the recurring cash account logic engine 112. In some embodiments, the cash flow forecast engine 110 may be configured to determine a baseline cash flow based on these outputs and, in some embodiments, to generate a graphical display for displaying the cash flow forecast to a user on a user interface of a client device.

In some embodiments, the cash flow forecast engine 110 may be configured to identify recurring transactions in a database of transactions (for example, past transactions) and generate a model for predicting future recurring transactions. Predicted recurring transactions for a given period may then be used by the cash flow forecast engine 110 in determining or predicting a baseline cash flow forecast.

The capital management platform 102 may be configured to generate, on a user interface, a visual display of a predicted cash flow of the entity for the period of time based on the predicted capital shortfalls and/or capital surpluses. For example, the visual display may comprise a graphical representation of the predicted cash flow for each day of the time period. An example screenshot of the visual display of the capital management platform 102 is shown in FIG. 2.

Referring now to FIG. 2, there is shown an example screenshot 200 of a visual display of the capital management platform 102. The screenshot 200 illustrates a graphical forecast or prediction relating to cash flow of a primary entity. This may include predictions relating to transactions, bills and/or invoices. Bills may comprise future payment obligations to one or more counterparties or related entities. Invoices may comprise future receivables from one or more counterparties or related entities. Section 202 provides an exemplary 30 day summary of a cash flow forecast for the primary entity, which may include forecasts for the entity's invoices and bills. Section 204 provides a graphical illustration of the cash flow forecast over the next 30 days for the entity. Points below the x-axis in the graph 204 indicate a negative total cash flow forecast at a particular point in time. Points above the x-axis indicate a positive cash flow forecast at a particular point in time. Section 204 comprises a baseline cash flow prediction line 210 indicating the cash flow position of the primary entity over the next 30 days.

Screenshot 200 also illustrates a selectable user input 214 allowing a user to select a particular account for which a cash flow prediction may be performed by the cash flow forecast engine 110. By selecting a different account from the selectable user input 214, a user may visualize a cash flow forecast for a different account for the entity. Screenshot 200 also illustrates another selectable user input 216 that allows a user to vary the duration over which the cash flow forecast engine 110 performs the cash flow prediction. A user may select a different duration of 60 days or 90 days, for example, to view a cash flow prediction over a different timescale.

Screenshot 200 also illustrates some financial data relating to invoices and bills which provides the basis for generation of the graphs in section 204. Section 218 illustrates a summary of financial data relating to invoices for the primary entity. In section 218, the financial data is summarized by the date on which an invoice is due. Section 220 illustrates a summary of financial data relating to bills for the primary entity. In section 220, the financial data is summarized by the date on which a bill is due.

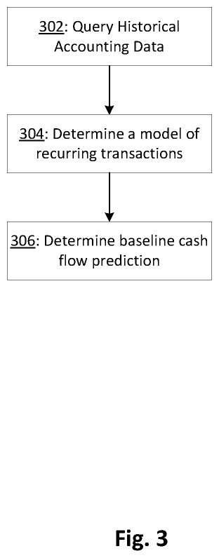

Referring now to FIG. 3, there is shown a process flow diagram 300 illustrating a method for forecasting cash flow for an entity, according to some embodiments. The cash flow forecast engine 110 may predict future cash flow of an entity based one of several techniques for predicting future cash flow based on past transactional data. The method of forecasting cash flow of FIG. 3 is an example of one of the methods of cash flow forecasting according to some embodiments. In some embodiments, one or more processors of the capital management platform 102 are configured to perform method 300.

At 302, the cash flow engine 110 determines financial or transactional data associated with a primary entity. For example, the cash flow engine 110 may query the database 106 to retrieve financial data, such as historical accounting data or transactional data relating to the primary entity. In some embodiments, the financial data is historical time series transactional data. Each record in the historical time series transactional data may comprise an amount and a date associated with the amount. In some embodiments, each record in the historical time series transactional data may comprise an amount, a date associated with the amount, and one or more other entities involved in the transaction. The historical data may provide a basis for determination of one or more models for prediction of future cash flow, such as models of recurring transactions. Once a cash flow prediction model is determined for a particular entity, the model may be varied over time as more data is made available to improve the accuracy of the cash flow prediction model. The transactional data may include data relating to one or more of: bank account transactions or transfers data, invoice data, billings data, expense claim data, cash flow data, quotes related data, sales data, purchase order data, receivables data, transaction reconciliation data, balance sheet data, profit and loss data, or payroll data, for example.

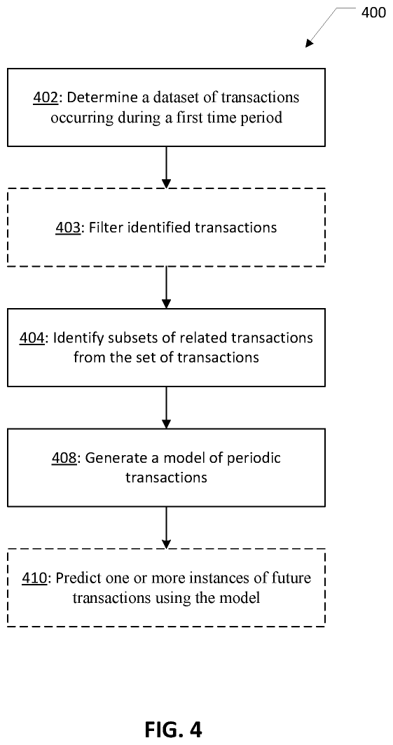

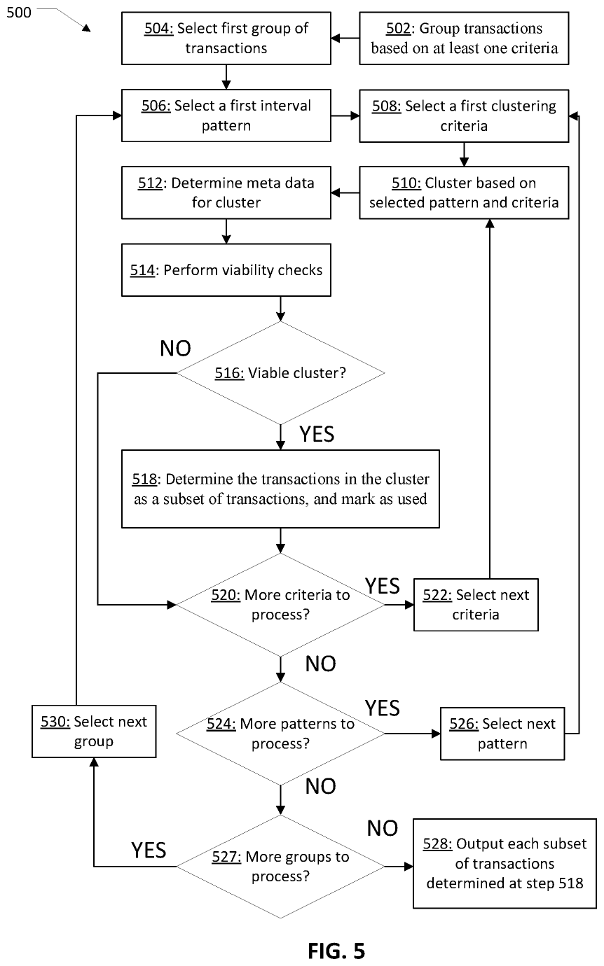

At 304, the cash flow engine 110 determines one or more models of recurring transactions. According to some embodiments, cash flow engine 110 may determine one or more models of recurring transactions by executing method 400 and/or method 500, as described in further detail below with reference to FIGS. 4 and 5.

At 306, based on the model determined at 304, cash flow forecast engine 110 determines future cash flow predictions. The steps 302 to 304 may be performed separately for different categories of historical transaction data records for an entity. For example, steps 302 to 304 may be separately performed for an entity's sales transaction data, expenses transaction data, payroll transaction data, for example. The historical transaction data may be appropriately characterized and sectored or categorized to individually model each sector or category. At step 306, the output of each model determined for an entity may be projected into the future to determine an overall future cash flow prediction for the entity.

Referring now to FIG. 4, there is shown a process flow for a method 400 of generating models identifying recurring transactions in a dataset of transactions. One or more models generated using method 400 may be used to predict one or more instances of future recurring transactions associated with a particular transaction attribute, such as an entity or particular account that is associated with the transaction. Accordingly, the step of determining a baseline cash flow prediction at 306 of method 300 may employ the model to predict recurring transactions and determine a baseline cash flow prediction. In some embodiments, the cash flow forecast engine 110, when executed by one or more processors of the capital management platform 102, is configured to perform method 400.

At step 402 of method 400, the cash flow forecast engine 110 determines and/or retrieves a dataset of transactions occurring during a first pre-determined time period. According to some embodiments, the pre-determined time period may be a period of time prior to the date on which method 400 is being performed. For example, the time period may be a duration of months prior to the date on which method 400 is being performed, such as a duration of 3 months. The dataset of transactions may be determined or obtained from database 106. Database 106 may comprise financial information associated with a network of entities associated with the capital management platform 102, and may, for example, include accounting data for transactions between two or more entities and one or more accounts associated with each of those entities. The transactions may be associated with one or more entities or contacts or may be associated with a network of entities. Each transaction is associated with corresponding transaction attribute information, such as date of the transaction, account name or type, account number, account name, contact name, contact identifier, payment or invoice amount, business registration number (such as ABN, NZBN, UK Companies House number, or the like), and/or contact address.

Optionally at step 403, the transactions identified at step 402 may be filtered using one or more filtering criteria. According to some embodiments, the criteria may be selected to remove transactions from the dataset that are less likely to relate to a set of recurring transactions. For example, in some embodiments, transactions that are less than a predetermined amount may be considered to be less likely to be recurring transactions, and therefore desirable to filter out of the dataset. A minimum transaction amount may therefore be selected as a filter amount. The minimum transaction amount may be $5, $20 or $50, for example. The minimum transaction amount may be selected to be likely to filter out non-recurring transactions while retaining recurring transactions.

At step 404, the cash flow forecast engine 110 attempts to identify one or more subsets of related transactions from the dataset of transactions that may relate to one or more recurring transactions. The related transactions may be any transactions that have similar or substantially corresponding values for one or more of the attributes of the transactions. In some embodiments, each subset of related transactions is determined by identifying a group of transactions that have one or more common attributes. For example, the common attributes may include one or more of a common transacting entity; a common bank account name, number or type; a common transaction amount; a common contact name or contact identifier such as business registration number (such as ABN, NZBN, UK Companies House number, or the like), and/or contact address. According to some embodiments, cash flow forecast engine 110 determines subsets of related transactions that may relate to recurring transactions by executing method 500, as described in further detail below with reference to FIG. 5. In some embodiments, no suitable subsets may be identified, in which case method 400 may terminate.

Where suitable subsets of transactions are identified at step 404, then at step 408, the cash flow forecast engine 110 generates a model of periodic transactions based on the identified subset(s) of related transactions and the interval for each of the subset(s). The model includes, for each of the subset(s), the interval and at least one of the common attributes common to each of the related transactions. At optional step 410, the cash flow forecast engine 110 then uses the model to predict one or more instances of future recurring transactions which may, for example, be associated with a particular entity or particular account of an entity. The predicted recurring transactions may then be used to determine the baseline cash flow prediction of method 300 at step 306, as described above. For example, the model may be associated with particular recurring transactions and be indicative of one or more attributes of the transaction: (i) payment amount; (ii) regularity of payment; (iii) day(s), week(s), month(s), and/or year(s) on which payment is predicted to be paid; (iv) account to and/or from which payment is predicted to be made; and (v) contact to and/or from which payment is predicted to be made.

The performance of method 400 can be measured using metrics such as coverage and precision. These metrics may be determined by counting the number of predicted transactions and actual future transactions over a predetermined time window. For example, according to some embodiments, the number of transactions predicted to occur one month after the date the predictions are generated may be counted, and the number of actual transactions that occur in the same time period, being one month after the date the predictions are generated, are also counted.

The coverage refers to the proportion of predictions made correctly for each organization to the number of actual future transactions of that organization, and may be calculated by dividing the number of correct predictions by the total number of future transactions for the organization. For example, an organization may have 100 transactions in the future (as at the date the predictions are being generated). Performing method 400 may cause 80 future transactions to be predicted. Of these, 60 may be correct, while 20 may be incorrect. The coverage may be determined by dividing the number of correctly predicted transactions (60 in this example) by the number of actual future transactions (100 in this example), which may give a coverage of 0.6 in this example.

The precision refers to the proportion of correctly predicted transactions for an organization to the total number of predicted transactions for that organization, and may be calculated by dividing the number of correctly predicted transactions by the total number of predicted transactions for the organization. For the above example, the coverage may be determined by dividing the number of correctly predicted transactions (60 in the above example) by the total number of predicted transactions (80 in this example), which may give a coverage of 0.75 in this example.

Where no predictions are made for an organization, the prediction may be undefined, as the denominator of the calculation is zero. If an organization doesn't have any transactions, the coverage may be undefined, as the denominator of the calculation is zero.

An experiment was conducted by performing method 400 on a dataset containing transactions randomly sampled from 100,000 organizations. The coverage and precision of the predicted results was determined, and are provided below.

| Metric | Metric Value |
|---|---|
| Precision mean | 0.4214 |
| Precision median | 0.4286 |
| Precision undefined | 30,241 |
| Coverage mean | 0.1078 |
| Coverage median | 0.0309 |
| Coverage undefined | 4929 |

FIG. 5 is a process flow diagram of a method for determining at least one subset of related transactions from a dataset of transactions, and which may be used at 404 of method 400. The cash flow forecast engine 110, when executed by one or more processors of the capital management platform 102, may be configured to perform method 500.

At step 502, the cash flow forecast engine 110 receives the group of transactions from the dataset of transactions identified at step 402 and/or 403 of method 400, and groups the transactions based on at least one grouping criteria. According to some embodiments, the grouping criteria may include one or more attributes shared among the transactions to be grouped. For example, the common attributes may include one or more of a common transacting entity; a common bank account name, number or type; a common transaction amount; a common contact name or contact identifier such as business registration number (such as ABN, NZBN, UK Companies House number, or the like), and/or contact address.

In some embodiments, such as where the transactions weren't already filtered during method 400, the received transactions in the one or more groups may be filtered using one or more filtering criteria. According to some embodiments, the criteria may be selected to remove transactions from the dataset that are less likely to significantly impact the cash flow of an organization. According to some embodiments, the criteria may be selected to remove transactions from the dataset that are less likely to relate to a set of recurring transactions. For example, in some embodiments, transactions that are less than a predetermined amount may be considered to be less likely to have an effect on cash flow, and therefore desirable to filter out of the dataset. A minimum transaction amount may therefore be selected as a filter amount. The minimum transaction amount may be $5, $20 or $50, for example. In some embodiments, transactions that are less than a predetermined amount may be considered to be less likely to be recurring transactions, and therefore desirable to filter out of the dataset. The minimum transaction amount may be selected to be likely to filter out non-recurring transactions while retaining recurring transactions.

According to some embodiments, the grouped transactions may optionally be sorted into a predetermined order within each group. For example, the transactions may be sorted by transaction date. In some embodiments, the transactions may be sorted by transaction date in descending order, such that the most recent transactions appear first in the dataset in each group. This may assist in the performance of the clustering process described below by ensuring the algorithm is looking at the most recent transactions first, which may be more likely to be relevant.

At step 504, cash flow forecast engine 110 selects a first group of transactions from the groups identified at step 502.

At step 506, the cash flow forecast engine 110 selects a first interval pattern for the purpose of identifying possible recurring transactions. The interval pattern may be any interval of time on which a transaction may recur. For example, the interval pattern may be a week, fortnight, month, quarter, or year, in some embodiments. According to some embodiments, cash flow forecast engine 110 may have access to a stored list of interval patterns, and may select the shortest of these interval patterns as a first interval pattern. For example, where the list of interval patterns comprises the intervals of a week, fortnight or month, cash flow forecast engine 110 may select a week as the first interval pattern.

At step 508, the cash flow forecast engine 110 selects at least one first clustering criteria. Clustering criteria may include any criteria that may help to identify whether a group of transactions are recurring transactions. For example, clustering criteria may include one or more of a deviation from a transaction interval based on the selected interval pattern, a difference in transaction amount, and a minimum number of transactions in a pattern, for example. A large set of transactions that do not deviate from a determined transaction interval and that all have a similar transaction amount are more likely to relate to a recurring transaction. Transactions that significantly deviate from a transaction interval, that significantly differ in payment amount and/or that only comprise a small set of transactions are less likely to be useful in building a model of recurring transactions.

According to some embodiments, cash flow forecast engine 110 may select at least one first clustering criteria from a stored list of clustering criteria, which may be ordered from strictest to most lenient. A strict criteria may be defined as a criteria that selects fewer transactions, while a more lenient criteria may be a criteria that selects a larger group of transactions. For example, where a weekly interval pattern has been selected, a transaction interval deviation of zero would be a strict clustering criteria, while a transaction interval deviation of three might be a lenient clustering criteria. An allowed difference in payment amount of 1% may be a strict clustering criteria, while an allowed difference in payment amount of 20% may be a lenient clustering criteria. Cash flow forecast engine 110 may select one or more of the strictest clustering criteria as a first clustering criteria.

At step 510, based on the interval pattern selected at step 506 and the clustering criteria selected at step 508, the cash flow forecast engine 110 creates a cluster of transactions that meet the criteria from the group of transactions selected at step 504. For example, if the interval pattern was weekly, and the clustering criteria was a deviation from the transaction interval of one, a difference in transaction amount of 10%, and a minimum transactions number of 10, cash flow forecast engine 110 may be configured to create a cluster where the transactions in the cluster have a transaction date separated by an interval of between 6 and 8 days, that differ in transaction amount by a maximum of 10%, and that contain at least 10 transactions.

To determine which transactions in the group of transactions selected at step 504 meet the criteria for the interval pattern, the cash flow forecast engine 110 may first calculate an interval difference between at least one pair of transactions in the subset or group of transactions selected at step 504. In some embodiments, cash flow forecast engine 110 may calculate an interval difference between each of the transactions in the subset or group of transactions selected at step 504. The cash flow forecast engine 110 may then determine whether each calculated interval difference is within the allowable deviation from the selected transaction interval.

According to some embodiments, the interval difference may be calculated using at least the month and date of the transaction date of each selected transaction, and calculating the difference between the transactions dates. The difference may be expressed as a number of days. For example, where there are three selected transactions with transaction dates of 10 Nov. 2022, 10 Dec.r 2022, and 10 Jan. 2023, the cash flow forecast engine 110 may determine that the interval differences are 30 and 31 days.

In some embodiments, the cash flow forecast engine 110 may use just the day of the week or day or date of the month to calculate the interval difference between two transaction dates. This may reduce the computational power required to determine each of the interval differences, and reduce the effect of missing transactions and differences in the lengths of different months on the interval calculations.

For example, where the selected interval pattern is a monthly interval pattern, the cash flow forecast engine 110 may use only the day of the month to determine the interval difference, by determining a difference in the day of the month on which each pair of transactions took place. Where there are three selected transactions with transaction dates of 10 Nov. 2022, 10 Dec. 2022, and 10 Jan. 2023, the cash flow forecast engine 110 may simply use the date of the month on which each transaction was performed, being the 10th in each case for this example. Cash flow forecast engine 110 may determine the difference between the dates of the month, and see whether the interval difference is within the allowable deviation from the selected transaction interval. In the above example, as all of the transactions fall on the same date of the month, cash flow forecast engine would determine the deviation from the monthly transaction interval to be 0. Cash flow forecast engine 110 may therefore determine that the transactions follow a monthly interval pattern. This may produce a more accurate result than calculating the actual number of days between each transaction as described above, as this method does not need to take into account the number of days in each month, which would otherwise affect the calculation of the interval difference.

Where the selected interval pattern is a weekly or fortnightly pattern, the cash flow forecast engine 110 may use only the day of the week to determine the interval difference, by determining a difference in the day of the week on which each pair of transactions took place.

Cash flow forecast engine 110 may take the cyclical nature of the calendar into account when calculating the interval differences. For example, while the 1st and the 30th may be considered 29 days apart when looking at the date of the month on which a transaction occurred, due to the cyclical nature of dates flowing into a new month cash flow forecast engine 110 may consider these dates to be close together to one another. For example, where there are three selected transactions with transaction dates of 30 Nov. 2022, 1 Jan. 2022, and 31 Jan. 2023, cash flow forecast engine 110 may determine that these transactions have a monthly interval pattern, although the dates of the month on which these transactions occur are not numerically close to one another (being the 30th, 1st and 31st).

In order to achieve this, cash flow forecast engine 110 may calculate the shortest distance between two days or dates where the days are mapped to a circle or considered to wrap, such that the day with the highest value is considered to be adjacent to the day with the lowest value. For example, when the interval pattern is weekly, the days of the week may be given the values of 1, 2, 3, 4, 5, 6 and 7, and mapped such that 7 is considered to be adjacent to 1. In this manner, when determining the distance between day 1 and day 3, the shortest distance would be 2, as it takes two steps to get from 1 to 3. If the numbers from 1 to 7 were mapped to a circle in a clockwise manner, it would take two steps moving clockwise to get from 1 to 3. When determining the distance between day 1 and day 7, the shortest distance would be 1, as it takes one step to get from 1 to 7. If the numbers from 1 to 7 were mapped to a circle in a clockwise manner, it would take one step moving anti-clockwise to get from 1 to 7.

In some alternative embodiments, cash flow forecasting engine 110 may map the determined dates of the month to a trigonometric function such as sine or cosine before comparing the dates to determine the transaction interval. Cash flow forecasting engine 110 may then determine a difference in the trigonometric value corresponding to the dates on which the pair of transactions took place. While the numerical difference between the first and last day of a month such as the 1st and 31st is 30 days, mapping this to a trigonometric function would result in the difference of these dates being 1. Having determined a cluster of transactions, at step 512 cash flow forecast engine 110 determines at least one attribute or meta data value relating to the cluster. According to some embodiments, the attribute may include one or more of: the date of the last transaction in the cluster; an individual transaction interval value for each transaction in the cluster; an interval value relating to the cluster; and the number of transactions in the cluster.

According to some embodiments, the attribute may include one or more interval values relating to the subset of transactions. Each interval may be indicative of a periodicity of the subset. The distribution of individual transactions in a subset may be regular or irregular. A single individual transaction may occur on the 15th day of every month, in which case the distribution of individual transactions in the subset would be regular and the interval of the subset would be monthly. Multiple individual transactions may occur regularly, for example, on particular days of the week, such as every Monday and Friday, in which case the distribution of individual transactions in the subset would be irregular and the interval of the subset would be weekly. Similarly, multiple payments may occur on different days of a month, for example, the 3rd, 5th, 27th and 29th of the month, and these transactions may occur every month. Accordingly, the distribution of the individual transactions within the subset is irregular, and the interval of the subset itself is monthly.

In some embodiments, individual transaction intervals of related transactions of the subset, that is the time period (e.g. day(s)) between a first related transaction and a next occurring/occurred related transaction, are determined. The interval of the subset may then be determined as being the median of the individual transactions intervals of the related transactions. In other embodiments, a distribution of the individual transactions intervals of the related transactions is compared with one or more template or model distributions, each associated with a periodic distribution, such as weekly, monthly etc. The interval of the subset(s) may be determined based on the template or model distributions to which the distribution of the individual transactions intervals most closely matches.

In some embodiments, a binned median interval may be calculated for the cluster. Individual transaction intervals may be placed into bins defining ranges of intervals. This may be done by first calculating individual transaction intervals as described above. The individual transaction intervals may then be rounded to the nearest multiple of the expected interval based on the interval selected as the interval patterns at step 506. For example, where a “weekly” interval pattern was selected, and the individual transaction intervals were calculated as being [7, 6, 6, 14, 14, 8], these would be rounded to [7, 7, 7, 14, 14, 7].The number of occurrences of each interval in the list is then counted. In this case, the interval ‘7’ appears 4 times, and the interval ‘14’ appears 2 times. The interval with the highest count may then be used to determine the actual interval of the subset. In this example, as ‘7’ has the highest count, the interval of the subset may be determined to be ‘weekly’.

In some alternative examples, rather than rounding the individual intervals, bins of interval ranges may be created, and the individual intervals may be placed in the bins before counting. In the above example, bins of 0-3 days, 4 -10 days, and 11-17 days may be defined. Each interval may be placed into a corresponding bin, and the bin with the highest number of intervals may be used to determine the most common interval in the subset. In the above example, the intervals [7, 6, 6, 8] would be placed in the 4-10 day bin, while the intervals [14, 14] would be placed in the 11-17 day bin. The centroid value of the defined bin (i.e. 7 for 4-10 and 14 for 11-17) having the highest count might then be used to determine the interval of the subset.

In some embodiments, suitable template distributions may be selected based on a type of account, or the account name, relating to the transactions being assessed. For example, if the account name is Payroll, and employees are generally paid on the last Thursday of the month, a template of a monthly distribution may be used to determine or identify the interval and/or a sufficient regularity of the occurrence of the related transactions. In other embodiments, an assessment of historical payments from a particular account name to a particular contact or contact type may be assessed to determine a pattern of regular payments, and may be used to generate a distribution model for use in assessing the regularity of related transactions for particular account names and/or contacts.

At step 514, the cash flow forecast engine 110 may perform one or more viability checks on the identified cluster. The viability checks may be used to determine whether the transactions in the identified cluster are likely to be examples of transactions forming a recurring transaction pattern with the interval selected at step 506. According to some embodiments, the viability checks may include checking one or more of: the recency of the latest transaction in the cluster; the extent to which the intervals of the cluster match a determined pattern; and the number of unique transactions in the cluster. Checking the recency of the latest transaction in the cluster may comprise determining the difference between the date of the last transaction in the cluster as determined in step 512 and the current date, and determining if the difference is less than a predetermined threshold. For example, a cluster may be determined unviable if the latest transaction in the cluster is determined to have occurred more than a month, three months, six months or a year before the date of processing. According to some embodiments, the threshold may be determined based on the interval pattern selected at step 506. For example, where the selected interval pattern is ‘weekly’ the threshold may be lower than when the selected interval pattern is ‘monthly’.

Checking the extent to which the intervals of the cluster match a determined pattern may include checking whether the transactions fit the pattern selected at 506. As transactions may fit into more than one pattern, cash flow forecast engine 110 may use the intervals for the cluster calculated at step 512 to determine whether the transactions in the selected cluster do fit the selected pattern. For example, cash flow forecast engine 110 may compare the interval defined by the selected interval pattern as selected at step 506 with the median or binned median interval pattern calculated at step 512.Where the calculated interval for the cluster does not match the interval defined by the selected pattern, the cluster is determined to be unviable. This may occur where the selected pattern is a “fortnightly” interval pattern, but the clustered transactions actually form a weekly interval pattern, for example.

Checking the number of unique transactions in the cluster may comprise comparing the number of transactions in the cluster with a predetermined threshold. The cluster may be deemed to be unviable if the number of transactions in the cluster is less than a predetermined threshold. According to some embodiments, the threshold may be 5, 10 or 15 transactions, for example.

According to some embodiments, the viability checks may also include an interval check based on the individual transaction intervals of related transactions that may have been calculated at step 512. According to some embodiments, the interval check may comprise determining whether any of the individual transaction intervals are zero, indicating multiple transactions that occurred on the same day. As having multiple transactions on a given day means that more than one transaction could fit in a particular position in a pattern of recurring transactions, where at least one such transaction interval is identified the cash flow forecast engine 110 may consider the cluster unviable. According to some embodiments, the cash flow forecast engine 110 may consider the cluster unviable if more than a threshold amount of individual transaction intervals are zero. For example, cash flow forecast engine 110 may consider the cluster unviable if more than half of the individual transaction intervals in the subset are zero.

According to some embodiments, in order to allow for drift in transaction dates within a pattern, the cash flow forecast engine 110 executing step 514 may first round each individual transactions interval to the nearest multiple of the identified pattern length. For example, where the pattern length is 7 days or one week, the individual transactions intervals may be rounded to the nearest multiple of seven, such that the set of intervals [1, 5, 0, 12, 9] would be rounded to [0, 7, 0, 14, 7]. This avoids mere drift in transaction dates causing subsets of transactions to pass the interval check.

At step 516, the cash flow forecast engine 110 determines if the cluster identified at step 510 was a viable cluster, based on the checks performed at step 514. According to some embodiments, the cluster may be deemed unviable if it fails at least one of the described checks. If the cluster is determined to be unviable, the cash flow forecast engine 110 moves to step 520, as described in further detail below.

If, at step 516, the cash flow forecast engine 110 determines that a viable cluster was formed, the cash flow forecast engine 110 moves to step 518. At step 518, the cash flow forecast engine 110 adds the transactions forming the viable cluster to the subset of transactions that will be output at step 528, to be further processed at step 406 of method 400, as described above. The cash flow forecast engine 110 also marks the transactions as “used”, so that these transactions are not re-used in future clustering attempts.

At step 520, the cash flow forecast engine 110 determines whether there exist further clustering criteria as described above with reference to step 508 that have yet to be used. If the cash flow forecast engine 110 determines that there do exist further clustering criteria, the cash flow forecast engine 110 subsequently performs step 522.

At step 522, the cash flow forecast engine 110 selects a different clustering criteria to be used for the clustering step at 510. According to some embodiments, the cash flow forecast engine 110 may select at least one clustering criteria that is more lenient than the previous clustering criteria used at step 510. Once the clustering criteria has been selected, cash flow forecast engine 110 returns to step 510 to re-cluster the transactions in an attempt to identify new viable clusters. By iterating through steps 510 to 522 and selecting more lenient clustering criteria each time, transactions that meet stricter clustering criteria can be identified and marked as used, increasing the chance that each transaction is allocated to the cluster that it fits best. According to some embodiments, only transactions marked as used, or transactions that have already been determined to make up a viable cluster, are not included in further iterations, meaning that any transactions previously clustered where the cluster was ultimately found to be unviable are included in the next clustering iteration at step 510.

If the cash flow forecast engine 110 determines that there do not exist further clustering criteria, the cash flow forecast engine 110 subsequently performs step 524. At step 524, the cash flow forecast engine 110 determines whether there exist further interval patterns as described above with reference to step 506 that have yet to be used. If the cash flow forecast engine 110 determines that there do exist further interval patterns, the cash flow forecast engine 110 subsequently performs step 526.

At step 526, the cash flow forecast engine 110 selects a different interval pattern to be used for the clustering step at 510. According to some embodiments, the cash flow forecast engine 110 may select an interval pattern that is longer in duration than the previous interval pattern used at step 510. Once the interval pattern has been selected, cash flow forecast engine 110 returns to step 508 to select clustering criteria and subsequently re-cluster the transactions in an attempt to identify new viable clusters. By iterating through steps 506 to 526 and selecting longer interval patterns each time, transactions that meet shorter interval patterns can be identified and removed from the dataset, decreasing the chance that a recurring transaction with a short recurrence interval is misidentified as being part of a group of recurring transactions with a longer recurrence interval. According to some embodiments, only transactions marked as used, or transactions that have already been determined to make up a viable cluster, are not included in further iterations, meaning that any transactions previously clustered where the cluster was ultimately found to be unviable are included in the next clustering iteration at step 510.

If the cash flow forecast engine 110 determines that there do not exist further interval patterns, the cash flow forecast engine 110 may instead perform step 527. At step 527, the cash flow forecast engine 110 determines whether there exist further groups of transactions as described above with reference to steps 502 and 504 that have yet to be processed. If the cash flow forecast engine 110 determines that there do exist further groups, the cash flow forecast engine 110 subsequently performs step 530.

At step 530, cash flow forecast engine 110 selects the next identified group of transactions as identified at step 502, and returns to step 506 to select a first interval pattern for the new group.

If the cash flow forecast engine 110 determines that there do not exist further groups of transactions to process, the cash flow forecast engine 110 may instead perform step 528. At step 528, cash flow forecast engine 110 may output each of the subsets of viable transactions determined at step 518 for further processing, as described above with reference to step 406 of method 400. The identified subsets may be processed as described above with reference to FIG. 4 to generate models of periodic transactions and predict one or more future transactions.

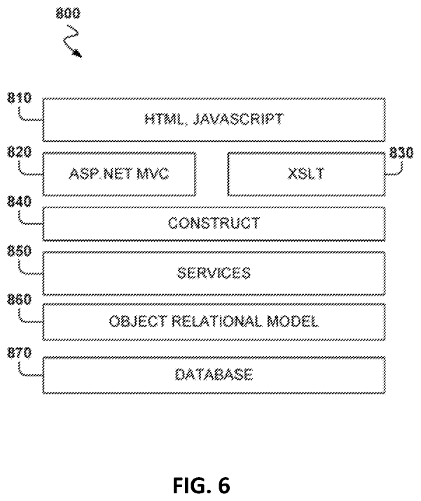

FIG. 6 is a block diagram depicting an example application framework 800, according to some embodiments. The application framework 800 may be an end-to-end web development framework enabling a “software as a service” (SaaS) product. The application framework 800 may include a hypertext markup language (HTML) and/or JavaScript layer 810, ASP.NET Model-View-Controller (MVC) 820, extensible stylesheet language transformations (XSLT) 830, construct 840, services 850, object relational model 860, and database 870.

The HTML and/or JavaScript layer 810 provides client-side functionality, such as user interface (UI) generation, receipt of user input, and communication with a server. The client-side code may be created dynamically by the ASP.NET MVC 820 or the XSLT 830. Alternatively, the client-side code may be statically created or dynamically created using another server-side tool. The ASP.NET MVC 820 and XSLT 830 provide server-side functionality, such as data processing, web page generation, and communication with a client. Other server-side technologies may also be used to interact with the database 870 and create an experience for the user.

The construct 840 provides a conduit through which data is processed and presented to a user. For example, the ASP.NET MVC 820 and XSLT 830 can access the construct 840 to determine the desired format of the data. Based on the construct 840, client-side code for presentation of the data is generated. The generated client-side code and data for presentation is sent to the client, which then presents data. In some example embodiments, when the MLP is invoked to analyze an entry, the MVC website makes an HTTP API call to a Python-based server. Also, the MVC website makes another HTTP API call to the Python-based server to present the suggestions to the user. The services 850 provide reusable tools that can be used by the ASP.NET 820, the XSLT 830, and the construct 840 to access data stored in the database 870. For example, aggregate data generated by calculations operating on raw data stored in the database 870 may be made accessible by the services 850.

The object relational model 860 provides data structures usable by software to manipulate data stored in the database 870. For example, the database 870 may represent a many-to-one relationship by storing multiple rows in a table, with each row having a value in common. By contrast, the software may prefer to access that data as an array, where the array is a member of an object corresponding to the common value. Accordingly, the object relational model 860 may convert the multiple rows to an array when the software accesses them and perform the reverse conversion when the data is stored.

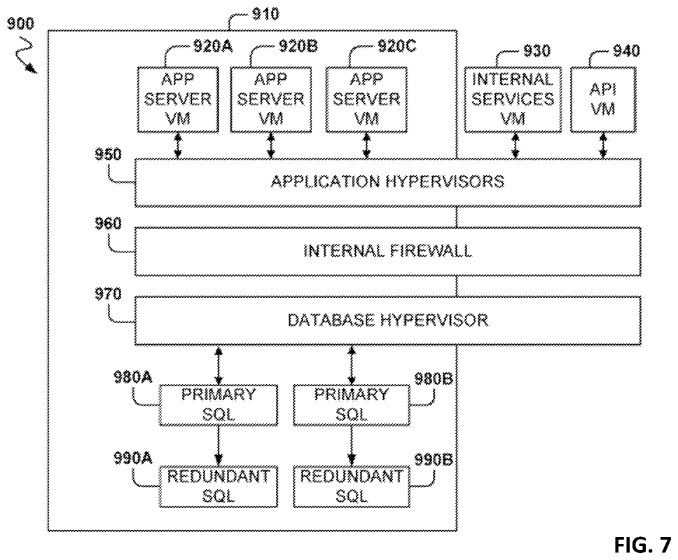

FIG. 7 is a block diagram depicting an example hosting infrastructure 900, according to some embodiments. The platform 600 may be implemented using one or more pods 910. Each pod 910 includes application server virtual machines (VMs) 920 (shown as application server virtual machines 920A-920C in FIG. 7) that are specific to the pod 910 as well as application server virtual machines that are shared between pods 910 (e.g., internal services VM 930 and application protocol interface VM 940). The application server virtual machines 920-940 communicate with clients and third- party applications via a web interface or an API. The application server virtual machines 920-940 are monitored by application hypervisors 950. In some example embodiments, the application server virtual machines 920A-920C and the API VM 940 are publicly accessible while the internal services VM 930 is not accessible by machines outside of the hosting infrastructure 900. The app server VMs 920A-920C may provide end-user services via an application or web interface. The internal services VM 930 may provide back-end tools to the app server VMs 920A-920C, monitoring tools to the application hypervisors 950, or other internal services. The API VM 940 may provide a programmatic interface to third parties. Using the programmatic interface, the third parties can build additional tools that rely on the features provided by the pod 910. An internal firewall 960 ensures that only approved communications are allowed between the database hypervisor 970 and the publicly accessible virtual machines 920-940. The database hypervisor 970 monitors the primary SQL servers 980A and 980B and the redundant SQL servers 990A and 990B. The virtual machines 920-940 can be implemented using Windows 8008 R2, Windows 8012, or another operating system. The support servers can be shared across multiple pods 910. The application hypervisors 950, internal firewall 960, and database hypervisor 970 may span multiple pods 910 within a data center.

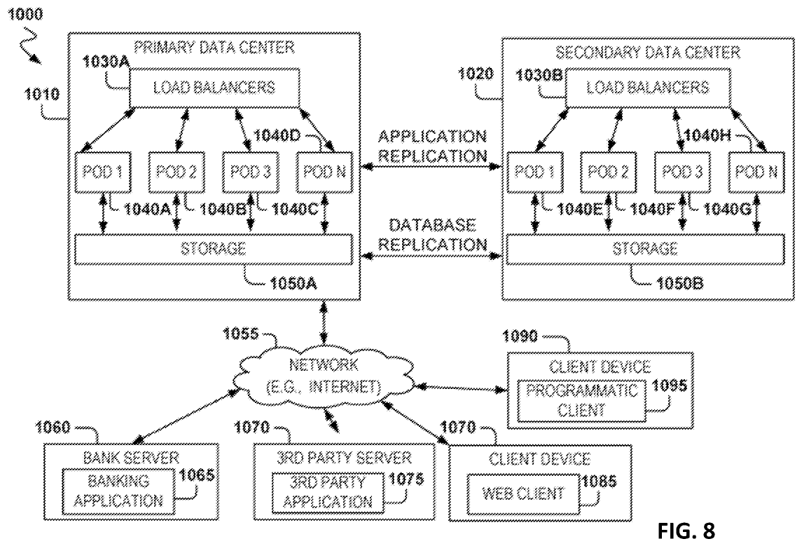

FIG. 8 is a block diagram depicting an example data center system 1000 for implementing embodiments. The primary data center 1010 services customer requests and is replicated to the secondary data center 1020. The secondary data center 1020 may be brought online to serve customer requests in case of a fault in the primary data center 1010. The primary data center 1010 communicates over a network 1055 with bank server 1060, third party server 1070, client device 1070, and client device 1090. The bank server provides banking data (e.g., via a banking application 1065). The third- party server 1070 is running third party application 1075. Client devices 1080 and 1090 interact with the primary data center 1010 using web client 1085 and programmatic client 1095, respectively. Within each data center 1010 and 1020, a plurality of pods, such as the pod 910 of FIG. 7, are shown. The primary data center 1010 is shown containing pods 1040a-1040d. The secondary data center 1020 is shown containing pods 1040e-1040h. The applications running on the pods of the primary data center 1010 are replicated to the pods of the secondary data center 1020. For example, EMC replication (provided by EMC Corporation) in combination with VMWare site recovery manager (SRM) may be used for the application layer replication. The database layer handles replication between a storage layer 1050a of the primary data center and a storage layer 1050b of the secondary data center. Database replication provides database consistency and the ability to ensure that all databases are at the same point in time. The data centers 1010 and 1020 use load balancers 1030a and 1030b, respectively, to balance the load on the pods within each data center. The bank server 1060 interacts with the primary data center 1010 to provide bank records for bank accounts of the client. For example, the client may provide account credentials to the primary data center 1010, which the primary data center 1010 uses to gain access to the account information of the client.

The bank server 1060 can provide the banking records to the primary data center 1010 for later reconciliation by the client using the client device 1080 or 1090. The third-party server 1070 may interact with the primary data center 1010 and the client device 1080 or 1090 to provide additional features to a user of the client device 1080 or 1090.

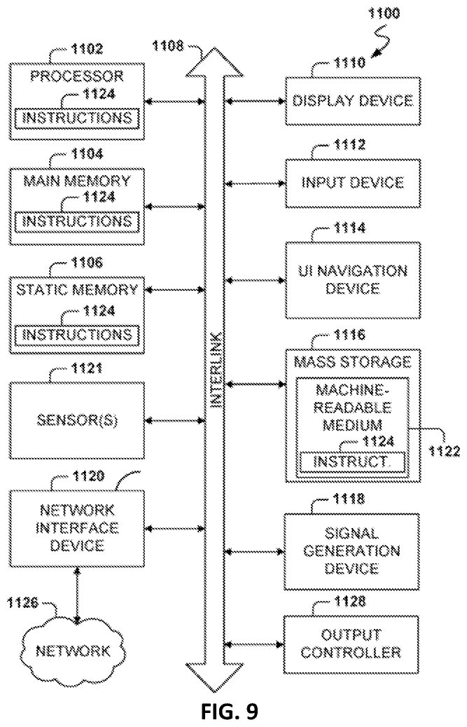

FIG. 9 is a block diagram illustrating an example of a machine upon which one or more example embodiments may be implemented. In alternative embodiments, the machine 1100 may operate as a standalone device or may be connected (e.g., networked) to other machines. In a networked deployment, the machine 1100 may operate in the capacity of a server machine, a client machine, or both in server-client network environments. In an example, the machine 1100 may act as a peer machine in peer-to-peer (P2P) (or other distributed) network environment. The machine 1100 may be a personal computer (PC), a tablet PC, a set-top box (STB), a laptop, a mobile telephone, a web appliance, a network router, switch or bridge, or any machine capable of executing instructions (sequential or otherwise) that specify actions to be taken by that machine. Further, while only a single machine 1100 is illustrated, the term “machine” shall also be taken to include any collection of machines that individually or jointly execute a set (or multiple sets) of instructions to perform any one or more of the methodologies discussed herein, such as cloud computing, SaaS, or other computer cluster configurations.

Examples, as described herein, may include, or may operate by, logic or a number of components, or mechanisms. Circuitry is a collection of circuits implemented in tangible entities that include hardware (e.g., simple circuits, gates, logic, etc.). Circuitry membership may be flexible over time and underlying hardware variability. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a computer-readable medium physically modified (e.g., magnetically, electrically, moveable placement of invariant massed particles, etc.) to encode instructions of the specific operation.

In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, the computer-readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry, at a different time.

The machine (e.g., computer system) 1100 may include a hardware processor 1102 (e.g., a central processing unit (CPU), a graphics processing unit (GPU), a hardware processor core, or any combination thereof), a main memory 1104, and a static memory 1106, some or all of which may communicate with each other via an interlink (e.g., bus) 1108. The machine 1100 may further include a display device 1110, an alphanumeric input device 1112 (e.g., a keyboard), and a UI navigation device 1114 (e.g., a mouse). In an example, the display device 1110, input device 1112, and UI navigation device 1114 may be a touch screen display. The machine 1100 may additionally include a mass storage device (e.g., drive unit) 1116, a signal generation device 1118 (e.g., a speaker), a network interface device 1120, and one or more sensors 1121, such as a global positioning system (GPS) sensor, compass, accelerometer, or another sensor. The machine 1100 may include an output controller 1128, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 1116 may include a machine-readable medium 1122 on which is stored one or more sets of data structures or instructions 1124 (e.g., software) embodying or utilized by any one or more of the techniques or functions described herein. The instructions 1124 may also reside, completely or at least partially, within the main memory 1104, within static memory 1106, or within the hardware processor 1102 during execution thereof by the machine 1100. In an example, one or any combination of the hardware processor 1102, the main memory 1104, the static memory 1106, or the storage device 1116 may constitute machine-readable media.

While the machine-readable medium 1122 is illustrated as a single medium, the term “machine-readable medium” may include a single medium or multiple media (e.g., a centralized or distributed database, and/or associated caches and servers) configured to store the one or more instructions 1124.

The term “machine-readable medium” may include any medium that is capable of storing, encoding, or carrying instructions 1124 for execution by the machine 1100 and that cause the machine 1100 to perform any one or more of the techniques of the present disclosure, or that is capable of storing, encoding or carrying data structures used by or associated with such instructions 1124. Non-limiting machine-readable medium examples may include solid-state memories, and optical and magnetic media. In an example, a massed machine-readable medium comprises a machine-readable medium 1122 with a plurality of particles having invariant (e.g., rest) mass. Accordingly, massed machine-readable media are not transitory propagating signals. Specific examples of massed machine-readable media may include: non-volatile memory, such as semiconductor memory devices (e.g., Electrically Programmable Read-Only

Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks. The instructions 1124 may further be transmitted or received over a communications network 1126 using a transmission medium via the network interface device 1120 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 1102.11 family of standards known as Wi-Fi®, IEEE 1102.16 family of standards known as WiMax®), IEEE 1102.15.4 family of standards, peer-to-peer (P2P) networks, among others. In an example, the network interface device 1120 may include one or more physical jacks (e.g., Ethernet, coaxial, or phone jacks) or one or more antennas to connect to the communications network 1126.

In an example, the network interface device 1120 may include a plurality of antennas to wirelessly communicate using at least one of single-input multiple- output (SIMO), multiple-input multiple-output (MIMO), or multiple-input single-output (MISO) techniques. The term “transmission medium” shall be taken to include any intangible medium that is capable of storing, encoding or carrying instructions 1124 for execution by the machine 1100, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

What is claimed is:

1. A computer-implemented method comprising:
determining a dataset of transactions occurring during a first time period;
determining a subset of related transactions from the dataset of transactions, where each transaction in the subset of related transactions shares at least one common attribute;
selecting a first transaction interval pattern;
selecting a first clustering criteria;
based on the first transaction interval pattern and the first clustering criteria, identifying a first cluster of transactions from the subset of related transactions;
performing a viability check on the first cluster;
in response to the first cluster passing the viability check, determining a first viable cluster;
selecting one or more of:
a second clustering criteria, the second clustering criteria being more lenient than the first clustering criteria; and
a second transaction interval pattern, the second transaction interval pattern being longer in duration than the first transaction interval pattern;
based on (i) the first transaction interval pattern and the second clustering criteria and/or (ii) the second transaction interval pattern and the first clustering criteria, identifying a second cluster of transactions from the subset of related transactions that have not already been determined to make up a viable cluster;
performing a viability check on the second cluster;
in response to the second cluster passing the viability check, determining a second viable cluster; and
generating a model of periodic transactions based on the first viable cluster and the second viable cluster, the model including: (i) a first interval related to the first transaction interval pattern or (ii) the first interval and a second interval related to the second transaction interval pattern, and a common attribute based on the at least one common attribute.

2. The method of claim 1, further comprising marking the transactions of a cluster as used.

3. The method of claim 1, further comprising, prior to identifying the first cluster, filtering the subset of related transactions based on at least one filtering criteria.

4. The method of claim 3, where the filtering criteria is a minimum transaction amount.

5. The method of clam 1, further comprising using the model of periodic transactions to predict at least one future recurring transaction having an interval related to the second transaction interval pattern and a common attribute based on the at least one common attribute.

6. The method of claim 1, wherein performing a viability check on the cluster comprises checking one or more of: a recency of a latest transaction in the cluster; an extent to which individual transaction intervals of the cluster match a determined pattern; and a number of unique transactions in the cluster.

7. The method of claim 6, wherein checking the recency of the latest transaction in the cluster comprises determining the latest transaction in the cluster, determining a difference between a date of the latest transaction and a current date, and determining if the difference is less than a predetermined threshold, wherein where the difference is more than the predetermined threshold the cluster is determined to be unviable.

8. The method of claim 6, wherein checking the extent to which the individual transaction intervals of the cluster match a determined pattern comprises:
determining the individual transaction intervals by calculating the difference between each transaction and a next occurring transaction; and
determining a median transaction interval, and comparing the median transaction interval with an interval related to a selected transaction interval pattern,
wherein where the median transaction interval does not match the selected transaction interval pattern, the cluster is determined to be unviable.

9. The method of claim 8, wherein the median transaction interval is a binned median transaction interval, and wherein the binned median transaction interval is calculated by:
determining the individual transaction intervals by calculating the difference between each transaction and a next occurring transaction;
rounding each individual transaction interval to a nearest multiple of the selected transaction interval pattern;
counting the number of instances of each rounded transaction interval; and
determining the binned median transaction interval to be the rounded transaction interval with a highest count.

10. The method of claim 6, wherein checking the number of unique transactions in the cluster comprises determining whether the number of transactions in the cluster is more than a predetermined threshold, wherein where the difference is less than the predetermined threshold the cluster is determined to be unviable.

11. The method of claim 1, wherein performing a viability check on the cluster comprises performing an interval check, and wherein performing the interval check comprises: determining individual transaction intervals by calculating the difference between each transaction and a next occurring transaction; and determining whether less than half of the individual transaction intervals are zero; wherein if more than half of rounded individual transaction intervals are zero the cluster is determined to be unviable.

12. The method of claim 11, further comprising rounding each individual transaction interval to a nearest multiple of the selected transaction interval pattern before determining whether less than half of the individual transaction intervals are zero.

13. The method of claim 1, wherein the common attribute is at least one of a common transacting entity; a common bank account name, number or type; a common transaction amount; a common contact name or contact identifier such as business registration number, and/or a common contact address.

14. The method of claim 1, wherein clustering criteria comprises at least one of a deviation from a selected interval pattern, a difference in transaction amount, and a minimum number of transactions to be clustered.

15. The method of claim 1, wherein identifying a cluster of transactions from the subset of related transactions based on the first transaction interval pattern comprises calculating an interval difference between at least one pair of transactions in the subset of related transactions.

16. The method of claim 15, wherein calculating an interval difference comprises determining a difference in a day of a month on which the pair of transactions took place.

17. The method of claim 16, wherein determining a difference comprises mapping days to a circle and determining a shortest number of steps between days corresponding to the pair of transactions.

18. The method of claim 15, wherein calculating an interval difference comprises mapping a date of a transaction to a trigonometric function, and determining a difference in a trigonometric value corresponding to dates on which the pair of transactions took place.

19. A computer-readable medium storing executable instructions which, when executed by a processor, perform operations comprising:
determining a dataset of transactions occurring during a first time period;
determining a subset of related transactions from the dataset of transactions, where each transaction in the subset of related transactions shares at least one common attribute;
selecting a first transaction interval pattern;
selecting a first clustering criteria;
based on the first transaction interval pattern and the first clustering criteria, identifying a first cluster of transactions from the subset of related transactions;
performing a viability check on the first cluster;
in response to the first cluster passing the viability check, determining a first viable cluster;
selecting one or more of:
a second clustering criteria, the second clustering criteria being more lenient than the first clustering criteria; and
a second transaction interval pattern, the second transaction interval pattern being longer in duration than the first transaction interval pattern;
based on (i) the first transaction interval pattern and the second clustering criteria and/or (ii) the second transaction interval pattern and the first clustering criteria, identifying a second cluster of transactions from the subset of related transactions that have not already been determined to make up a viable cluster;
performing a viability check on the second cluster;
in response to the second cluster passing the viability check, determining a second viable cluster; and
generating a model of periodic transactions based on the first viable cluster and the second viable cluster, the model including: (i) a first interval related to the first transaction interval pattern or (ii) the first interval and a second interval related to the second transaction interval pattern, and a common attribute based on the at least one common attribute.

20. A system comprising:
one or more processors; and
memory comprising computer executable instructions, which when executed by the one or more processors, cause the system to:
determine a dataset of transactions occurring during a first time period;
determine a subset of related transactions from the dataset of transactions, where each transaction in the subset of related transactions shares at least one common attribute;
select a first transaction interval pattern;
select a first clustering criteria;
based on the first transaction interval pattern and the first clustering criteria, identify a first cluster of transactions from the subset of related transactions;
perform a viability check on the first cluster;
in response to the first cluster passing the viability check, determine a first viable cluster;
select one or more of:
a second clustering criteria, the second clustering criteria being more lenient than the first clustering criteria; and
a second transaction interval pattern, the second transaction interval pattern being longer in duration than the first transaction interval pattern;
based on (i) the first transaction interval pattern and the second clustering criteria and/or (ii) the second transaction interval pattern and the first clustering criteria, identify a second cluster of transactions from the subset of related transactions that have not already been determined to make up a viable cluster;
perform a viability check on the second cluster;
in response to the second cluster passing the viability check, determine a second viable cluster; and
generate a model of periodic transactions based on the first viable cluster and the second viable cluster, the model including: (i) a first interval related to the first transaction interval pattern or (ii) the first interval and a second interval related to the second transaction interval pattern, and a common attribute based on the at least one common attribute.
